(19) United States
(12) Patent Application Publication
(10) Pub. No.: US 2025/0383294 A1
(43) Pub. Date: Dec. 18, 2025

(54) SPECKLE NOISE REDUCTION USING PUPIL MASKS

(71) Applicant: KLA Corporation, Milpitas, CA (US)

(72) Inventors: Guoheng Zhao, Palo Alto, CA (US); Jenn-Kuen Leong, San Jose, CA (US); Daniel Ivanov Kavaldjiev, San Jose, CA (US); John Fielden, Los Altos, CA (US)

(21) Appl. No.: 18/747,140

(22) Filed: Jun. 18, 2024

(51) Int. Cl. G01N 21/88; G01N 21/95

(52) U.S. Cl. CPC G01N 21/8806; G01N 21/95; G01N 2021/8822; G01N 2201/068

(57) ABSTRACT

An inspection system may include illumination optics to direct an illumination beam to a sample and an imaging sub-system to image the sample, where the imaging sub-system includes an objective lens to collect light from the sample as sample light and one or more speckle decorrelation masks in a collection pupil plane configured to control at least one of a phase or an intensity of at least a portion of the sample light. The system may further include a controller to receive two or more inspection images of the sample from the detector, where the two or more inspection images are generated with different configurations of the one or more speckle decorrelation masks selected to at least partially decorrelate the two or more inspection images, combine the inspection images to generate a composite image, and identify defects on the sample based on the composite image.

### TECHNICAL FIELD

The present disclosure relates generally to particle inspection and, more particularly, to reducing speckle during particle inspection.

### BACKGROUND

Particle detection systems (e.g., inspection systems) are commonly utilized in semiconductor processing lines to identify defects or particulates on samples (e.g., wafers) which may or may not have films or other structures. Many samples exhibit strong surface scattering (e.g., surface haze), which is often the limiting factor for defect detection sensitivity. There is therefore a need to develop systems and methods for reducing the impact of surface scattering during defect inspection.

### SUMMARY

In embodiments, the techniques described herein relate to an inspection system including an illumination sub-system including one or more lenses configured to direct an illumination beam to be directed to a sample; an imaging sub-system configured to image the sample on a detector, where the illumination sub-system and the imaging sub-system provide dark-field imaging of the sample, where the imaging sub-system includes an objective lens to collect light from the sample as sample light; and one or more speckle decorrelation masks in a collection pupil plane configured to control at least one of a phase or an intensity of at least a portion of the sample light; and a controller including one or more processors configured to execute program instructions causing the one or more processors to implement an inspection recipe by receiving two or more inspection images of the sample from the detector, where the two or more inspection images are generated with different configurations of the one or more speckle decorrelation masks selected to at least partially decorrelate the two or more inspection images; combining the two or more inspection images to generate a composite image; and identifying one or more defects on the sample based on the composite image.

In embodiments, the techniques described herein relate to an inspection system, where the different configurations of the one or more speckle decorrelation masks selected to at least partially decorrelate the two or more inspection images include different rotational orientations of a phase speckle decorrelation mask of the one or more speckle decorrelation masks, where the phase speckle decorrelation mask provides different phase shifts to different regions of the collection pupil plane.

In embodiments, the techniques described herein relate to an inspection system, where the phase speckle decorrelation mask provides the different phase shifts to different halves of the collection pupil plane.

In embodiments, the techniques described herein relate to an inspection system, where the phase speckle decorrelation mask provides a phase difference of between the different halves of the collection pupil plane.

In embodiments, the techniques described herein relate to an inspection system, where the different configurations of the one or more speckle decorrelation masks selected to at least partially decorrelate the two or more inspection images further include different azimuth incidence angles of the illumination beam.

In embodiments, the techniques described herein relate to an inspection system, where a first inspection image is generated with a first azimuth incidence angle of the illumination beam and a first configuration of the one or more speckle decorrelation masks, where a second inspection image is generated with a second azimuth incidence angle of the illumination beam and a second configuration of the one or more speckle decorrelation masks, where the sample light in a first region of a collection pupil of the imaging sub-system when generating the first inspection image and a second region of the collection pupil of the imaging sub-system when generating the second inspection image are correlated, where the different configurations of the one or more speckle decorrelation masks selectively block the sample light in at least one of the first region or the second region to at least partially decorrelate the first inspection image and the second inspection image.

In embodiments, the techniques described herein relate to an inspection system, where the first azimuth incidence angle is orthogonal to the second azimuth incidence angle.

In embodiments, the techniques described herein relate to an inspection system, where the first region and the second region are associated with an overlap area of a projected collection pupil associated with generating the first inspection image in a global spatial frequency domain with a projected collection pupil associated with generating the second inspection image in the global spatial frequency domain.

In embodiments, the techniques described herein relate to an inspection system, where the first configuration of the one or more speckle decorrelation masks includes a first blocker shaped to block the sample light associated with a first portion of the overlap area, where the second configuration of the one or more speckle decorrelation masks includes a second blocker shaped to block the sample light associated with a remaining portion of the overlap area.

In embodiments, the techniques described herein relate to an inspection system, where the first configuration of the one or more speckle decorrelation masks provides a wedge aperture with an apex oriented at a location of the collection pupil associated with specular reflection of the illumination beam with the first azimuth incidence angle, where the second configuration of the one or more speckle decorrelation masks provides the wedge aperture with the apex oriented at a location of the collection pupil associated with specular reflection of the illumination beam with the second azimuth incidence angle.

In embodiments, the techniques described herein relate to an inspection system, where the objective lens has a numerical aperture equal to or greater than 0.7.

In embodiments, the techniques described herein relate to an inspection system, where the objective lens has a numerical aperture equal to or greater than 0.9.

In embodiments, the techniques described herein relate to an inspection method including generating two or more inspection images of a sample with an inspection system including one or more speckle decorrelation masks in a collection pupil plane configured to control at least one of a phase or an intensity of at least a portion of sample light collected in response to an illumination beam, where the two or more inspection images include dark-field images, where the two or more inspection images are generated with different configurations of the one or more speckle decorrelation masks selected to at least partially decorrelate the two or more inspection images; combining the two or more inspection images to generate a composite image; and identifying one or more defects on the sample based on the composite image.

In embodiments, the techniques described herein relate to an inspection method, where the different configurations of the one or more speckle decorrelation masks selected to at least partially decorrelate the two or more inspection images include different rotational orientations of a phase speckle decorrelation mask of the one or more speckle decorrelation masks, where the phase speckle decorrelation mask provides different phase shifts to different regions of the collection pupil plane.

In embodiments, the techniques described herein relate to an inspection method, where the phase speckle decorrelation mask provides the different phase shifts to different halves of the collection pupil plane.

In embodiments, the techniques described herein relate to an inspection method, where the phase speckle decorrelation mask provides a phase difference of between the different halves of the collection pupil plane.

In embodiments, the techniques described herein relate to an inspection method, where the different configurations of the one or more speckle decorrelation masks selected to at least partially decorrelate the two or more inspection images further include different azimuth incidence angles of the illumination beam.

In embodiments, the techniques described herein relate to an inspection method, where generating the two or more inspection images includes generating a first inspection image is with a first azimuth incidence angle of the illumination beam and a first configuration of the one or more speckle decorrelation masks; and generating a second inspection image with a second azimuth incidence angle of the illumination beam and a second configuration of the one or more speckle decorrelation masks, where the sample light in a first region of a collection pupil when generating the first inspection image and a second region of the collection pupil when generating the second inspection image are correlated, where the different configurations of the one or more speckle decorrelation masks selectively block the sample light in at least one of the first region or the second region to at least partially decorrelate the first inspection image and the second inspection image.

In embodiments, the techniques described herein relate to an inspection method, where the first azimuth incidence angle is orthogonal to the second azimuth incidence angle.

In embodiments, the techniques described herein relate to an inspection method, where the first region and the second region are associated with an overlap area of a projected collection pupil associated with generating the first inspection image in a global spatial frequency domain with a projected collection pupil associated with generating the second inspection image in the global spatial frequency domain.

In embodiments, the techniques described herein relate to an inspection method, where the first configuration of the one or more speckle decorrelation masks includes a first blocker shaped to block the sample light associated with a first portion of the overlap area, where the second configuration of the one or more speckle decorrelation masks includes a second blocker shaped to block the sample light associated with a remaining portion of the overlap area.

In embodiments, the techniques described herein relate to an inspection method, where generating the two or more inspection images includes generating the first inspection image with the first configuration of the one or more speckle decorrelation masks providing a wedge aperture with an apex oriented at a location of the collection pupil associated with specular reflection of the illumination beam with the first azimuth incidence angle; and generating the second inspection image with the second configuration of the one or more speckle decorrelation masks providing the wedge aperture with the apex oriented at a location of the collection pupil associated with specular reflection of the illumination beam with the second azimuth incidence angle.

In embodiments, the techniques described herein relate to an inspection system including a controller including one or more processors configured to execute program instructions causing the one or more processors to implement an inspection recipe by directing an imaging sub-system to generate two or more inspection images of a sample, where the imaging sub-system includes an objective lens to collect light from the sample as sample light; and one or more speckle decorrelation masks in a collection pupil plane configured to control at least one of a phase or an intensity of at least a portion of the sample light, where the two or more inspection images are generated with different configurations of the one or more speckle decorrelation masks selected to at least partially decorrelate the two or more inspection images; combining the two or more inspection images to generate a composite image; and identifying one or more defects on the sample based on the composite image.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a block diagram depicting an inspection system, in accordance with one or more embodiments of the present disclosure.

FIG. 1B illustrates a simplified schematic of the inspection system, in accordance with one or more embodiments of the present disclosure.

FIG. 2 illustrates a flow diagram illustrating steps performed in a method for sample inspection, in accordance with one or more embodiments of the present disclosure.

FIG. 3A illustrates projected pupils in a global spatial frequency domain for two imaging configurations with orthogonal azimuth incidence angles and a collection numerical aperture of 0.7, in accordance with one or more embodiments of the present disclosure.

FIG. 3B illustrates projected pupils in a global spatial frequency domain for two imaging configurations with orthogonal azimuth incidence angles and a collection numerical aperture of 0.9, in accordance with one or more embodiments of the present disclosure.

FIG. 4A illustrates the projected pupils of FIG. 3B in the global frequency domain with the addition of intensity decorrelation masks, in accordance with one or more embodiments of the present disclosure.

FIG. 4B illustrates one non-limiting set of complementary configurations of an intensity speckle decorrelation mask providing masking of complementary portions of an overlap area illustrated in FIG. 4A, in accordance with one or more embodiments of the present disclosure.

FIG. 4C illustrates another non-limiting set of complementary intensity decorrelation masks providing masking of complementary portions of the overlap area in FIG. 3B, in accordance with one or more embodiments of the present disclosure.

FIG. 5A illustrates decorrelated inspection images generated with a rotatable speckle decorrelation mask as illustrated in FIG. 4C, in accordance with one or more embodiments of the present disclosure.

FIG. 5B illustrates a plot depicting histograms of inspection images and a composite image, in accordance with one or more embodiments of the present disclosure.

FIG. 6A illustrates a top view of one non-limiting design of a phase speckle decorrelation mask, in accordance with one or more embodiments of the present disclosure.

FIG. 6B illustrates a side view of the phase speckle decorrelation mask in FIG. 6A, in accordance with one or more embodiments of the present disclosure.

FIG. 6C illustrates a plot of speckle correlation between inspection images generated with the phase speckle decorrelation mask at various rotational angles relative to an inspection image generated with the phase speckle decorrelation mask oriented at an angle of 0°, in accordance with one or more embodiments of the present disclosure.

FIG. 7 illustrates simulations of speckle suppression using the phase speckle decorrelation mask of FIGS. 6A-6B, in accordance with one or more embodiments of the present disclosure.

FIG. 8 illustrates simulations of speckle suppression using inspection images with different combinations of azimuth incidence angle of an illumination beam and rotational orientation of the phase speckle decorrelation mask of FIGS. 6A-6B, in accordance with one or more embodiments of the present disclosure.

FIG. 9 illustrates experimental results for speckle suppression using inspection images with different combinations of azimuth incidence angle of an illumination beam and rotational orientation of the phase speckle decorrelation mask of FIGS. 6A-6B, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing defect inspection with a speckle-reducing mask, which may be located at or near a pupil plane. In embodiments, multiple images of a sample are captured using different combinations of phase masks, intensity masks, and/or illumination incidence angle and combined (e.g., averaged or combined with another suitable technique) to form a combined image which may have a higher signal to noise ratio (SNR) than any of the constituent images. Put another way, the combined image may exhibit less speckle than any of the constituent images.

It is contemplated herein that speckle noise may be decreased (e.g., mitigated) by combining multiple images of the sample taken under different conditions, where the speckles in the different images are at least partially decorrelated. Speckle reduction is generally described in U.S. Pat. No. 9,176,072 issued Nov. 3, 2015; U.S. Pat. No. 10,739,275 issued Aug. 11, 2020; Goodman, Joseph W. Speckle phenomena in optics: theory and applications. 2^{nd} ed., SPIE Press, 2020, pp. 215-222; and Goodman, Joseph W. “Some properties of speckle from smooth objects.” Optical Engineering 49.6 (2010): 068001-068001; all of which are incorporated herein by reference in their entireties.

In some embodiments, multiple images with at least partially decorrelated speckles are generated by imaging the sample with a spatially non-uniform phase mask at different orientations. For example, a defect inspection system may include an adjustable phase mask providing different phase shifts for light in two or more regions of a collection area of a pupil plane. In this configuration, multiple images of a sample may be captured with the adjustable phase mask in different orientations (e.g., different angular orientations in the pupil plane) and mathematically combined to generate a combination image. As a non-limiting example, such a phase mask may introduce a phase difference of π between two halves of the collection area of the pupil plane.

Images of a sample taken with illumination at different azimuth incidence angles may also provide at least partially decorrelated speckle intensities.

In some embodiments, a defect inspection system selectively illuminates the sample from different azimuth illumination angles. In this configuration, multiple images of a sample may be captured with different combinations of the orientation of the adjustable phase mask and the orientation of the illumination beam and then mathematically combined to generate a combination image.

In some embodiments, a defect inspection system providing illumination at different azimuth incidence angles further includes an adjustable intensity speckle decorrelation mask, where the adjustable intensity speckle decorrelation mask is configured for each azimuth incidence angle to block one or more regions of a collection area of a pupil plane that may contribute to correlated speckle intensity when combined with images generated at different azimuth incidence angles. For example, speckle correlation may be calculated from pupil overlap projected to a global spatial frequency domain. In particular, a collection pupil associated with any particular combination of azimuth incidence angle and collection numerical aperture (NA) may be projected to global spatial frequency domain. Overlapping portions of projected collection pupils associated with different azimuth incidence angles may result in correlated speckles in the associated images, which may not be mitigated by combining (e.g., averaging) the associated images. However, an adjustable intensity mask configured to block at least some portions of the collection pupil that would lead to correlated speckles in captured images may lead to improved SNR when combining the images.

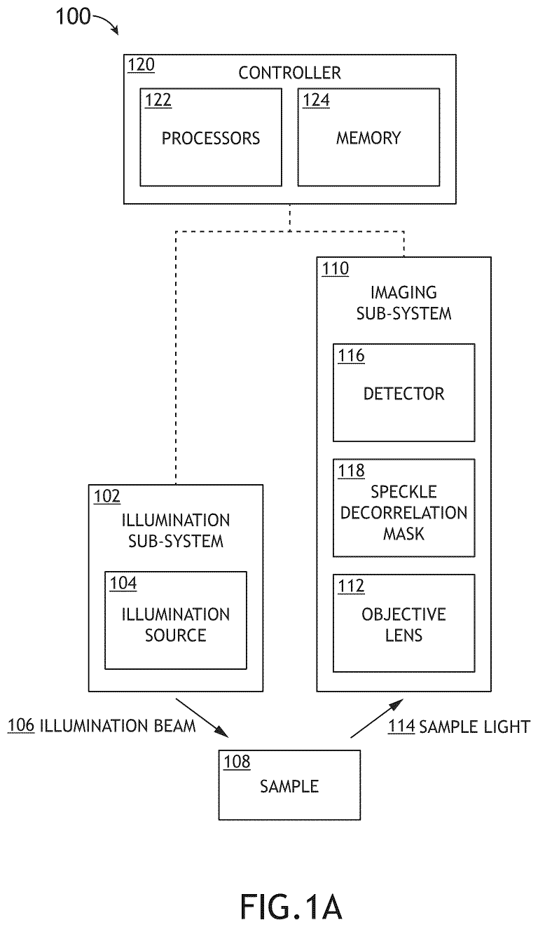

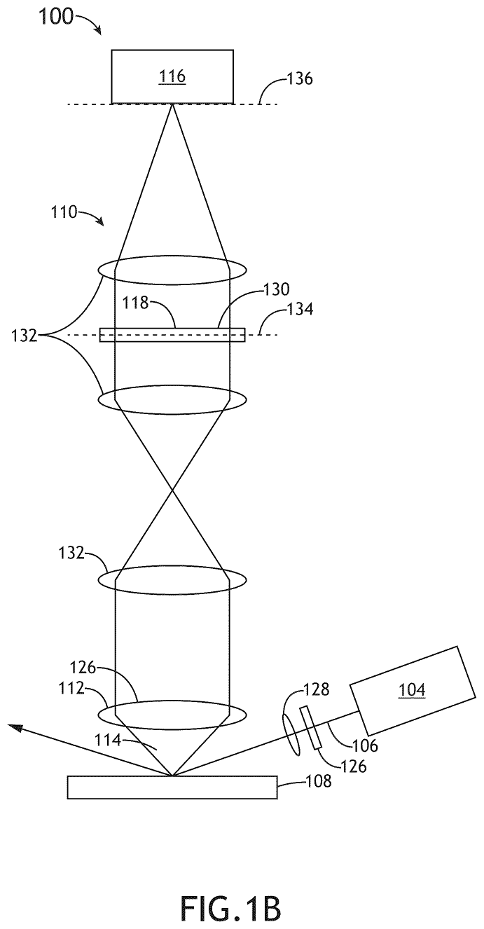

Referring now to FIGS. 1A-9, systems and methods providing speckle reduction are described in greater detail, in accordance with one or more embodiments of the present disclosure.

FIG. 1A is a block diagram depicting an inspection system 100, in accordance with one or more embodiments of the present disclosure. FIG. 1B is a simplified schematic of the inspection system 100, in accordance with one or more embodiments of the present disclosure.

In embodiments, the inspection system 100 includes an illumination sub-system 102, at least one illumination source 104 to generate at least one illumination beam 106, and direct this illumination beam 106 to a sample 108. The inspection system 100 may also include an imaging sub-system 110 with at least an objective lens 112 to image the sample 108 based on light emanating (e.g., scattered or diffracted) from the sample 108, which is referred to herein as sample light 114. For example, the imaging sub-system 110 may include one or more detectors 116 to generate images of the sample 108 (e.g., an illuminated portion thereof) based on at least a portion of collected sample light 114.

The inspection system 100 may in some embodiments illuminate a sample 108 from one or more azimuth incidence angles. For example, the inspection system 100 may include multiple sets of illumination sources 104 and/or other optical elements to generate multiple illumination beams 106 that may be selectively directed to the sample 108 at different incidence angles. As another example, the illumination sub-system 102 may control an incidence angle of a single illumination beam 106 on the sample 108. As an illustration, the illumination sub-system 102 may include an adjustable stop located in an illumination pupil plane to control the incidence angle of an illumination beam 106. As another illustration, the illumination sub-system 102 may control a position of light forming an illumination beam 106 in an illumination pupil plane to control the incidence angle.

The inspection system 100 can identify and/or characterize any type of defect on any type of sample 108, which is broadly referred to herein as inspection. In embodiments, the inspection system 100 can identify and/or characterize defects on samples 108 associated with semiconductor fabrication processes. For example, a sample 108 may include, but is not limited to, an unprocessed (e.g., bare) semiconductor wafer, a semiconductor wafer having one or more films, or a semiconductor wafer having one or more patterned features (e.g., patterned films). In this configuration, defects of interest may include, but are not limited to, particles on the sample 108 or structural damage to the sample 108 in the form of scratches, dents, pits, or the like.

In embodiments, the inspection system 100 may implement an inspection recipe (or any number of inspection recipes) that provides configuration information for various components of the inspection system 100. For example, an inspection recipe may include various properties of an illumination beam 106 to be directed to the sample 108 such as, but not limited to, incidence angle (e.g., azimuth and/or polar incidence angle), wavelength, or polarization. As another example, an inspection recipe may include various properties of the sample light 114 to be directed to the detector 116 to form an image such as, but not limited to, wavelength or polarization. As another example, an inspection recipe may include positions, orientations, or configurations of components of the imaging sub-system 110 such as, but not limited to, one or more speckle decorrelation masks 118. In this way, an inspection recipe may control an imaging configuration used to generate a particular inspection image.

In embodiments, as illustrated in FIG. 1B, the inspection system 100 is a dark-field imaging system configured to exclude specularly-reflected light during imaging. In this regard, the inspection system 100 may image the sample 108 based primarily on scattered or diffracted light. For example, defects on the sample 108 may scatter and/or diffract light, which may be captured by a dark-field imaging system.

Dark-field imaging may be implemented using any technique known in the art. For example, FIG. 1B illustrates a configuration in which the illumination sub-system 102 is arranged to direct the illumination beam 106 to the sample 108 at an oblique incidence angle that is excluded from a NA of an objective lens 112 used to collect sample light 114 for imaging. In this way, specular reflection of the illumination beam 106 may also be excluded from the NA of the objective lens 112 and not collected. The oblique incidence angle may generally include any selected incidence angle. For example, the incidence angle may be, but is not required to be, greater than 60 degrees with respect to a surface normal. As another example, though not shown, the illumination sub-system 102 may direct the illumination beam 106 to the sample 108 through the objective lens 112 and may further include one or more beam blocks (e.g., blockers) or apertures to prevent specular reflection of the illumination beam 106 from reaching a detector 116. It is noted that the inspection system 100 is not limited to dark-field imaging and may implement bright-field imaging or any other suitable imaging technique. In this way, the inspection system 100 may be configured as any type of imaging system known in the art. Further, the objective lens 112 may have any NA. For example, the NA may be equal to or greater than, but is not required to have, a NA equal to or greater than 0.7. As another example, the NA may be equal to or greater than 0.9. In some embodiments, the inspection system 100 may include one or more components to block specular reflection from reaching the detector 116.

It is contemplated herein that surface scattering from the sample (e.g., surface haze) may be a limiting factor for defect detection sensitivity, even in a dark-field imaging configuration. The strength of surface haze may depend on multiple factors including, but not limited to, incidence angle or polarization of the illumination beam 106. For example, the strength of surface haze may be relatively high for near-normal angles of incidence and may drop off for higher incidence angles. In embodiments, the illumination sub-system 102 directs the illumination beam 106 to the sample 108 at an oblique incidence angle to increase a defect signal (e.g. a strength of sample light 114 associated with a defect on the sample 108). The oblique incidence angle may generally include any selected incidence angle. For example, the incidence angle may be, but is not required to be, greater than 60 degrees with respect to a surface normal of the sample 108. However, this is not a limitation and the illumination beam 106 may be directed to the sample 108 at any incidence angle.

In embodiments, the inspection system 100 mitigates speckles associated with surface haze and thus increases a SNR of defect signals by mathematically combining multiple images of the sample 108 in which speckles associated with the surface haze is at least partially decorrelated. As used herein, the term inspection image is used to refer to an image of the sample 108 generated under any particular imaging configuration and the term composite image is used to refer to an image formed by combining multiple inspection images with different imaging configurations designed to provide decorrelated speckles associated with surface haze.

Surface haze may manifest in any particular image as noise that may mask or at least reduce a SNR of a signal from a small defect. However, mathematically combining decorrelated images of the sample 108 into a composite image may smooth out speckles from the surface haze, which may be associated with high spatial frequency noise, and improve the SNR associated with defect signals.

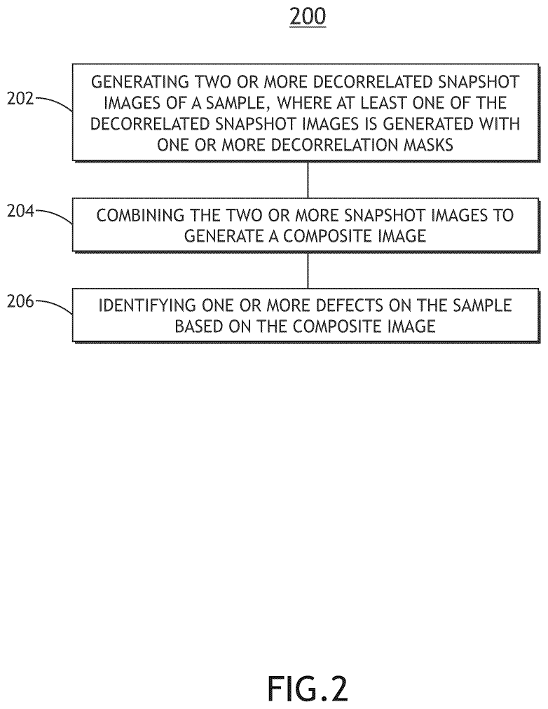

In embodiments, the inspection system 100 includes one or more speckle decorrelation masks 118 to at least partially decorrelate the speckle noise associated with surface haze in different inspection images. A speckle decorrelation mask 118 may include a phase mask, an intensity mask, or a combination thereof. The generation of inspection images with at least partially decorrelated speckles from surface haze is described in greater detail with respect to FIGS. 2-9.

In embodiments, the inspection system 100 further includes a controller 120 including one or more processors 122 configured to execute program instructions maintained on a memory 124 (e.g., memory medium). The controller 120 may be communicatively coupled to any components of the inspection system 100 such as, but not limited to, the detectors 116. For example, the controller 120 may receive data from any components of the inspection system 100 and/or direct, via control signals, any components of the inspection system 100 to perform various actions. In this way, the program instructions may cause the processors 122 to implement and/or direct the implementation of any of the process steps within the present disclosure. For example, the controller 120 may control or otherwise direct (e.g., via control signals) components such as, but not limited to, one or more illumination sources 104, one or more speckle decorrelation masks 118, or one or more detectors 116 to generate inspection images of a sample 108 using different imaging parameters designed to provide decorrelated speckles from surface haze. As another example, the controller 120 may receive, analyze, and/or process images of the sample 108 generated by a detector 116 (e.g., inspection images). As another example, the controller 120 may generate a composite image from two or more inspection images. As another example, the controller 120 may identify and/or characterize defects on the sample 108 based on a composite image.

Referring now to FIGS. 2-9, the generation of inspection images with different imaging conditions designed to provide at least partially decorrelated speckles from surface haze is described in greater detail, in accordance with one or more embodiments of the present disclosure.

FIG. 2 is a flow diagram illustrating steps performed in a method 200 for sample inspection, in accordance with one or more embodiments of the present disclosure. Applicant notes that the embodiments and enabling technologies described previously herein in the context of the inspection system 100 should be interpreted to extend to the method 200. For example, one or more steps of the method 200 may be performed by the controller 120 directly or indirectly (e.g., via control signals to other components of the inspection system 100). It is further noted, however, that the method 200 is not limited to the architecture of the inspection system 100.

In embodiments, the method 200 includes a step 202 of generating two or more decorrelated inspection images of a sample 108, where at least one of the decorrelated inspection images is generated with one or more speckle decorrelation masks 118. For example, the one or more speckle decorrelation masks 118 may be located in a collection pupil plane to control at least one of a phase or an intensity of at least a portion of sample light 114 collected in response to an illumination beam 106.

A speckle decorrelation mask 118 used for one inspection image may control a phase and/or intensity of at least a portion of sample light 114 used for imaging in a manner that reduces and/or eliminates correlation with at least another inspection image.

In embodiments, the method 200 includes a step 204 of combining the two or more inspection images to generate a composite image. The inspection images may be combined using any technique known in the art such as, but not limited to, averaging. In embodiments, the method 200 includes a step 206 of identifying one or more defects on the sample 108 based on the composite image.

The use of speckle decorrelation masks 118 to generate inspection images with decorrelated speckles from surface haze is now described in greater detail, in accordance with one or more embodiments of the present disclosure.

In some embodiments, a speckle decorrelation mask 118 used for one inspection image is designed to block a portion of the sample light 114 that may result in a correlation with another inspection image.

For example, one technique for providing images with at least partially decorrelated speckles from surface haze is by generating inspection images at different incidence angles (e.g., azimuth incidence angles). However, there are some conditions in which images generated at different incidence angles may be at least partially correlated. In these cases, one or more speckle decorrelation masks 118 may prevent such correlation.

One non-limiting framework for characterizing correlations between images taken at different incidence angles is to project collection pupils of different images to a global spatial frequency domain that relates a distribution of collected light to illumination conditions.

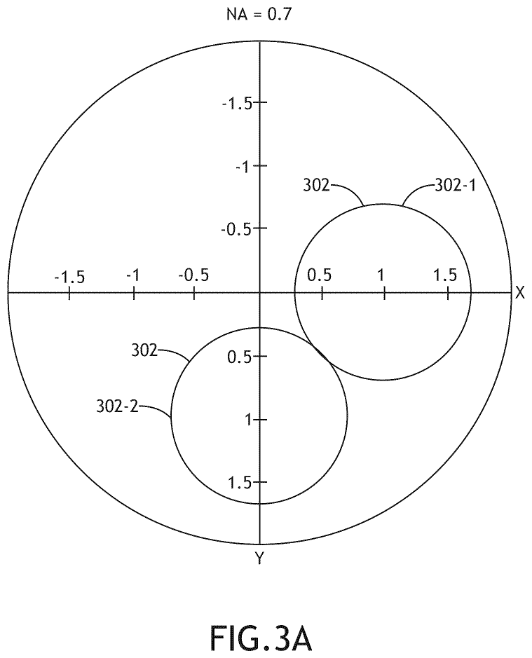

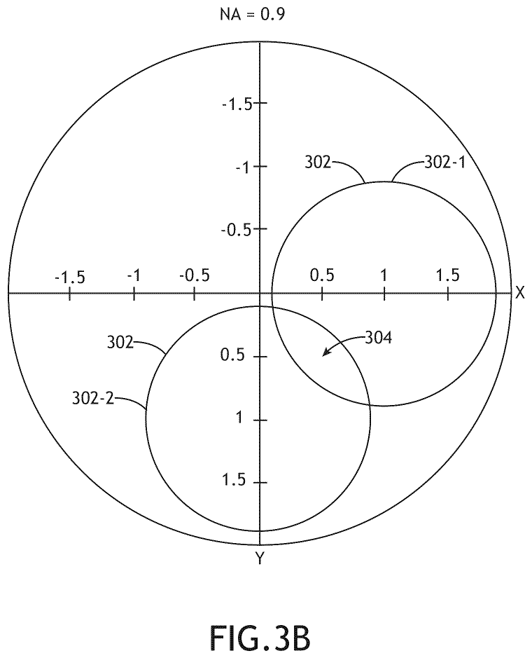

FIGS. 3A-3B illustrate the projection of collection pupil distributions to a global spatial frequency domain, where an origin of the global spatial frequency domain represents specular reflection of an illumination beam 106 (e.g., from any incidence angle), and where a position of a projected pupil in the global domain is related to both polar and azimuth incidence angles of an illumination beam 106. In this framework, speckle correlation may be calculated from an overlap of projected pupils associated with different illumination conditions. Put another way, speckles from surface haze in images generated with different illumination conditions may be at least partially correlated when projections of the associated collection pupils in the global spatial frequency domain at least partially overlap.

FIG. 3A illustrates projected pupils in a global spatial frequency domain for two imaging configurations with orthogonal azimuth incidence angles at the same polar incidence angle of 75 degrees and a collection NA (e.g., a collection NA of an objective lens 112) of 0.7, in accordance with one or more embodiments of the present disclosure. FIG. 3B illustrates projected pupils in a global spatial frequency domain for two imaging configurations with orthogonal azimuth incidence angles and a collection NA of 0.9, in accordance with one or more embodiments of the present disclosure.

In FIGS. 3A-3B, the X and Y axes represent spatial frequency in a global domain, where an origin of the plots (e.g., a centerpoint of the plots) represents specular reflection of an illumination beam 106 (e.g., from any incidence angle). A radius of a projected pupil 302 in this global domain may correspond to a NA of an objective lens 112 used to collect sample light 114. For example, the projected pupils 302 in FIG. 3A have a radius of 0.7, whereas the projected pupils 302 in FIG. 3B have a radius of 0.9. A position of a projected pupil 302 in the global domain is related to both polar and azimuth incidence angles of an illumination beam 106. As an illustration, a projected pupil associated with an illumination beam 106 at normal incidence (not shown) would be centered around the origin. However, a center of a projected pupil associated with an oblique illumination beam 106 deviates from the origin according to the incidence angle, where an azimuth angle in the global domain corresponds to an azimuth incidence angle of the illumination beam 106, and where a magnitude of this deviation along the radial direction corresponds to a polar incidence angle of the illumination beam 106.

Accordingly, FIGS. 3A-3B both illustrate a first projected pupil 302-1 associated with an illumination beam 106 with an azimuth incidence angle oriented along the X direction (e.g., a 0° azimuth incidence angle) and a second projected pupil 302-2 associated with an illumination beam 106 with an azimuth incidence angle oriented along the Y direction (e.g., a 90° azimuth incidence angle). Further, FIGS. 3A-3B both illustrate outside-the-lens (OTL) illumination in which a polar incidence angle of an illumination beam 106 is outside a collection NA of the objective lens 112. In particular, none of the projected pupils 302 in FIGS. 3A-3B include the origin associated with specular reflection of the illumination beam 106.

Speckle correlation between images associated with different illumination conditions may be determined based on an amount of overlap of the associated projected pupils 302 in the global spatial frequency domain as follows:

$$\vert {μ}_{12} ( {θ}_{1} , {ϕ}_{1} ; {θ}_{2} , {ϕ}_{2} \vert = \{ \begin{matrix}\frac{2}{π} \{ {cos}^{- 1} ( \frac{ρ}{{ρ}_{0}} ) - \frac{ρ}{{ρ}_{0}} \sqrt{1 - {[ \frac{ρ}{{ρ}_{0}} ]}^{2}} & ρ < {ρ}_{0} \\ 0 & ρ \geq {ρ}_{0}\end{matrix} \qquad ( 1 )$$

$$ρ = \frac{1}{λ} \sqrt{{( cos {ϕ}_{1} sin {θ}_{1} - cos {ϕ}_{2} sin {θ}_{2} )}^{2} - {( sin {ϕ}_{1} sin {θ}_{1} - sin {ϕ}_{2} sin {θ}_{2} )}^{2}} \qquad ( 2 )$$

$${ρ}_{0} = \frac{2 NA}{λ} , \qquad ( 3 )$$

where μ represents cross-correlation, subscripts refer to different imaging conditions, NA is a collection NA of an objective lens 112, λ is a wavelength of an illumination beam 106.

For situations where different imaging conditions utilize identical polar incidence angles of an illumination beam 106 (e.g., vary only based on azimuth incidence angle), Equation (2) reduces to:

$$ρ = \frac{2}{λ} sin θ sin \frac{\vert {ϕ}_{1} - {ϕ}_{2} \vert}{2} . \qquad ( 4 )$$

In this formulation, the normalized cross-correlation has the form of an incoherent optical transfer function (OTF) with a circular aperture, replacing spatial frequency with a distance in a Fourier plane of two illumination angles. It is also the normalized overlapping area of two circles of imaging NA (e.g., two projected pupils 302) with center offsets associated with the position in Fourier space of illumination angles.

Additionally, speckles associated with surface haze from smooth surfaces in which surface roughness is much lower than the wavelength (λ) may be completely correlated for opposite azimuth incidence angles (e.g., azimuth incidence angles of 0° and 180°, 90° and 270°, or the like). In this way, the largest separation of azimuthal incidence angles for least surface haze correlation is 90 degrees.

Returning to FIGS. 3A-3B, FIG. 3A depicts a configuration in which there is no overlap between the first projected pupil 302-1 and the second projected pupil 302-2. As a result, speckles in two inspection images generated under these conditions will be fully decorrelated. However, FIG. 3B depicts a configuration in which the first projected pupil 302-1 partially overlaps the second projected pupil 302-2 in an overlap area 304, which may also be referred to as a correlation zone. In this configuration, portions of light in each inspection image within the overlap area 304 of may be correlated. Put another way, speckles in the associated inspection images may be partially correlated. As a result, some features of the speckles associated with the light in this overlap area 304 may be consistent throughout both inspection images and thus not smoothed out in an associated composite image.

Based on Equations (1)-(4) and the non-limiting examples of FIGS. 3A-3B, one approach to providing inspection images with decorrelated surface haze is to use orthogonal azimuthal incidence angles and a collection NA selected along with the polar incidence angle to be small enough to avoid overlap of the projected pupils 302 as shown in FIG. 3A.

However, the collection NA controls an overall signal strength and it is often desirable to maximize the NA to the extent practical. Accordingly, benefits of reducing a collection NA to limit surface haze correlation between inspection images may be outweighed or at least reduced by undesirable reductions in the overall signal strength. For example, signal is approximately proportional to NA² such that there is an approximate 1.9× reduction of signal when reducing the collection NA from 0.97 to 0.7.

In some embodiments, a speckle decorrelation mask 118 is an intensity mask designed to block light during the generation of one inspection image that may be correlated with light in another inspection image. For example, such an intensity speckle decorrelation mask 118 may be placed in a collection pupil (e.g., a pupil plane associated with an imaging sub-system 110) when generating one inspection image to block regions of the collection pupil that may be correlated with light in another inspection image. As an illustration, an intensity speckle decorrelation mask 118 used to generate an inspection image based on the first projected pupil 302-1 may block at least a portion of light associated with the overlap area 304 to reduce or eliminate speckle correlation with an inspection image based on the second projected pupil 302-2.

It is contemplated herein that the use of an intensity speckle decorrelation mask 118 to selectively block portions of sample light 114 that result in correlations between inspection images may enable the use of a relatively high NA objective lens 112 while also reducing or eliminating correlations between inspection images. In particular, an intensity speckle decorrelation mask 118 designed to block some or all of the overlap area 304 when generating inspection images in a configuration such as FIG. 3B may provide higher signal strengths compared to a configured such as FIG. 3A in which the NA is reduced to avoid an overlap area 304.

An intensity speckle decorrelation masks 118 may have any design suitable for blocking all or part of light associated with an overlap area of projected pupils 302 in a global frequency domain.

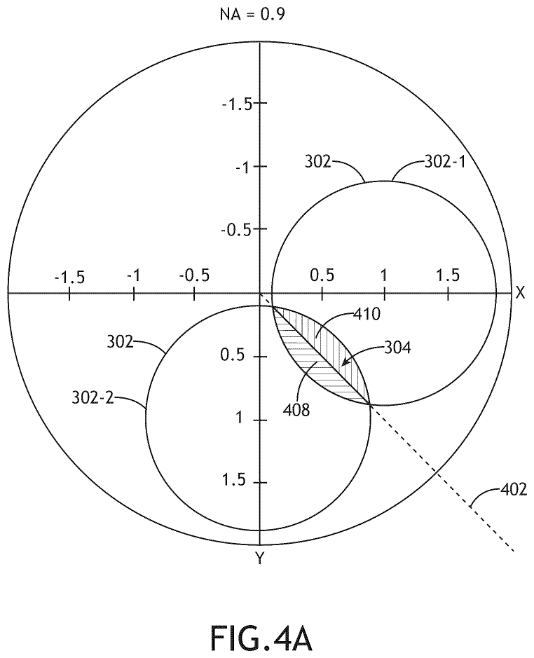

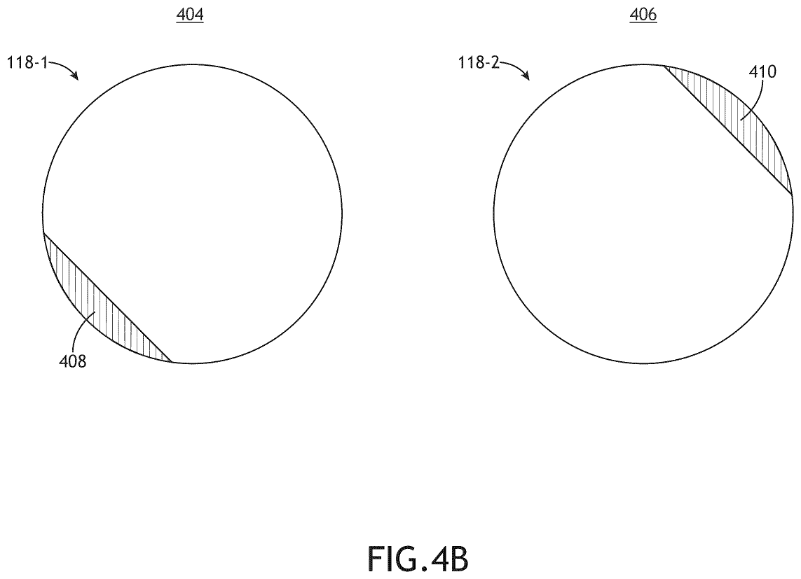

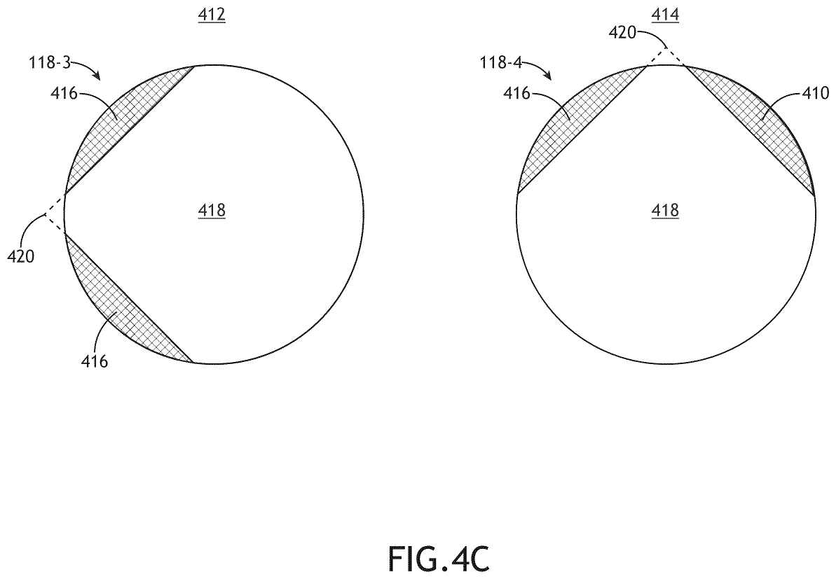

FIGS. 4A-4C illustrate a non-limiting example of a design of intensity speckle decorrelation masks 118 suitable for decorrelating inspection images generated with the projected pupils 302 illustrated in FIG. 3B.

In some embodiments, as depicted in FIGS. 4A-4C, intensity speckle decorrelation masks 118 for different inspection images are designed to block complementary portions of an overlap area 304 of associated projected pupils 302. In this way, light from any particular portion of the overlap area 304 is present in only one inspection image such that the different inspection images are decorrelated.

For example, FIG. 4A illustrates the projected pupils of FIG. 3B in the global frequency domain with the addition of intensity speckle decorrelation masks 118, in accordance with one or more embodiments of the present disclosure. In this particular example, the overlap area 304 may be divided along a line 402 oriented halfway between the azimuth incidence angles of the two projected pupils 302.

FIG. 4B illustrates one non-limiting set of complementary configurations of an intensity speckle decorrelation mask 118 providing masking of complementary portions of an overlap area 304 illustrated in FIG. 4A, in accordance with one or more embodiments of the present disclosure. The panel 404 illustrates a first configuration of a speckle decorrelation mask 118-1 suitable for use with the first projected pupil 302-1 and the panel 406 illustrates a second configuration of a speckle decorrelation mask 118-2 suitable for use with the second projected pupil 302-2.

In FIGS. 4A and 4B, the first configuration of an intensity speckle decorrelation mask 118-1 includes a blocker 408 that covers one half of the overlap area 304, whereas the second configuration of a speckle decorrelation mask 118-2 includes a blocker 410 that covers the other half of the overlap area 304. It is contemplated herein that this set of designs beneficially provides passes the same amount of light for both images and thus results in inspection images of uniform overall brightness. However, it is not a requirement that intensity speckle decorrelation masks 118 for two inspection images provide the same amount of light for both images. In a general sense, the blocker 408 and the blocker 410 may have any complementary shapes to block complementary portions of the overlap area 304.

An inspection system 100 may generate inspection images with the speckle decorrelation masks 118 depicted in FIG. 4B using any suitable technique. For example, the inspection system 100 may include the first configuration of a speckle decorrelation mask 118-1 and the second configuration of a speckle decorrelation mask 118-2 as separate components attached to an actuator (e.g., a translation stage). In this way, the actuator may selectively place the first configuration of a speckle decorrelation mask 118-1 in a collection pupil when imaging the sample 108 with an illumination beam 106 oriented along the X direction (e.g., corresponding to the first projected pupil 302-1) and selectively place the second configuration of a speckle decorrelation mask 118-2 in a collection pupil when imaging the sample 108 with an illumination beam 106 oriented along the Y direction (e.g., corresponding to the second projected pupil 302-2).

Further, since light in any portion of the overlap area 304 is only used to generate one of the inspection images (and not both), the resulting inspection images may be at least partially decorrelated. It is noted, however that light associated with opposite azimuthal angles may be at least partially correlated for relatively smooth surfaces (e.g., surfaces in which surface roughness is much lower than the wavelength (λ), but the correlation may generally decrease as the surface roughness increases. In this way, the configuration of an intensity speckle decorrelation mask 118-1 in FIG. 4B may be well suited for relatively rough surfaces.

FIG. 4C illustrates another non-limiting design of an intensity speckle decorrelation mask 118 providing masking of complementary portions of the overlap area 304 in FIG. 3B, in accordance with one or more embodiments of the present disclosure. It is noted that the design depicted in FIG. 4C may be well suited for, but not limited to, relatively smooth surfaces (e.g., surfaces in which surface roughness is much lower than the wavelength (λ)). The panel 412 illustrates a third configuration of a speckle decorrelation mask 118-3 suitable for use with the first projected pupil 302-1 and the panel 414 illustrates a fourth configuration of a speckle decorrelation mask 118-4 suitable for use with the second projected pupil 302-2. In FIG. 4C, the third configuration of a speckle decorrelation mask 118-3 and the fourth configuration of a speckle decorrelation mask 118-4 are simply rotational variants of each other and may thus be implemented with a single component. For example, this single component may be attached to a rotational actuator (e.g., a rotational translation stage) to provide the third configuration of the speckle decorrelation mask 118-3 when imaging the sample 108 with an illumination beam 106 oriented along the X direction (e.g., corresponding to the first projected pupil 302-1) and provide the fourth configuration of the speckle decorrelation mask 118-4 when imaging the sample 108 with an illumination beam 106 oriented along the Y direction (e.g., corresponding to the second projected pupil 302-2).

In FIGS. 4A and 4C, the third configuration of a speckle decorrelation mask 118-3 and the fourth configuration of a speckle decorrelation mask 118-4 include a pair of blockers 416 with complementary shapes to cover complementary portions of the overlap area 304.

It is noted that FIG. 4C depicts a particular design in which the pair of blockers 416 provide an open aperture 418 that has a wedge shape and an apex 420 oriented at a location of the collection pupil (and the global spatial frequency domain) associated with specular reflection of the illumination beam 106 in the particular orientation.

It is noted that the designs depicted in FIG. 4C may sacrifice a small amount of sample light 114 (e.g., associated with an unused blocker) and thus some image brightness relative to the designs depicted in FIG. 4B, but may beneficially utilize a single rotatable speckle decorrelation mask 118.

In some embodiments, an intensity speckle decorrelation mask 118 covering an entirety of the overlap area 304 is used for one of the inspection images, while the other of the inspection images is not generated with an intensity speckle decorrelation mask 118.

It is further not a requirement that two inspection images are fully decorrelated. Rather, reducing the correlation of speckle may improve the efficacy of mathematically combining (e.g., averaging, or the like) multiple inspection images to improve SNR and/or reduce speckle contrast.

Returning to the method 200 depicted in FIG. 2, the method 200 may include a step (not shown) of designing one or more speckle decorrelation masks 118 (e.g., intensity speckle decorrelation masks 118) by projecting collection pupils associated with imaging configurations of two or more inspection images to a global spatial frequency domain with an origin associated with specular reflection of an illumination beam, determining one or more overlap areas associated with areas of overlap of the projected collection pupils, and designing the one or more speckle decorrelation masks 118 to block complementary portions of the one or more overlap areas.

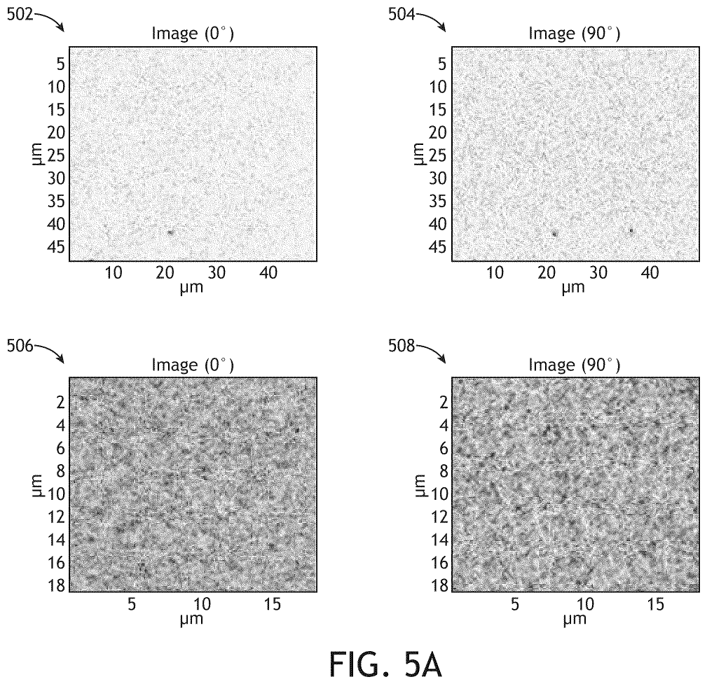

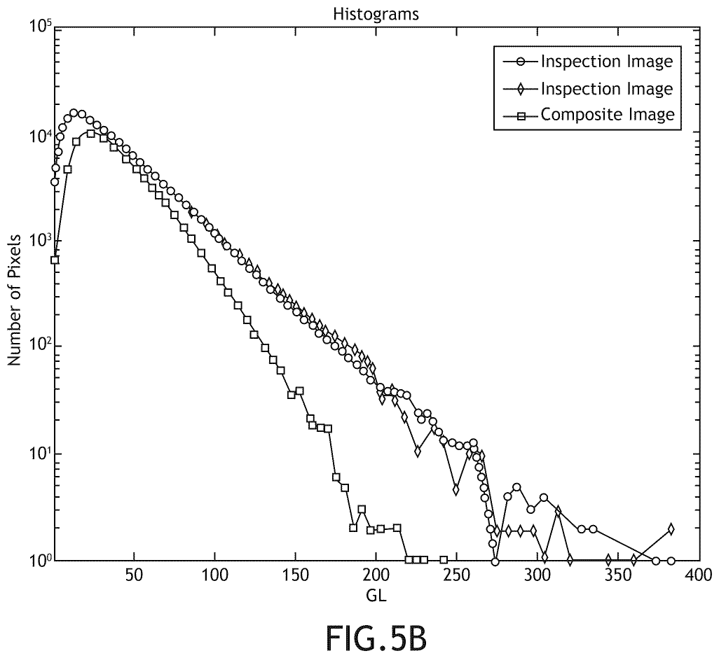

FIG. 5A illustrates decorrelated inspection images generated with a rotatable speckle decorrelation mask 118 as illustrated in FIG. 4C, in accordance with one or more embodiments of the present disclosure. Inspection image 502 was generated with an illumination beam 106 oriented along an X direction (e.g., a 0° azimuth incidence angle) and inspection image 504 was generated with an illumination beam 106 oriented along an Y direction (e.g., a 90° azimuth incidence angle). The image 506 and the image 508 correspond to a common portion of inspection image 502 and inspection image 504, respectively, and show speckle (e.g., surface haze) in greater detail. FIG. 5B illustrates a plot depicting histograms of one inspection image 502 (circle markers), another inspection image 504 (diamond markers), and a composite image (squared markers) formed by averaging the inspection image 502 with the inspection image 504, in accordance with one or more embodiments of the present disclosure. The horizontal axis is the image intensity in unit of gray levels (labeled as GL), and the vertical axis is the number of pixels at the corresponding gray level. The composite image has fewer at higher gray levels, indicating that the noise in the composite image is lower than each of the two inspection images acquired at two different azimuthal angles. The noise can be quantified by the speckle contrast, defined at the standard deviation of the image pixel gray level divided by the average of the image pixel gray level.

Table 1 further illustrates the speckle contrast improvement of the composite image relative to the inspection images for different convolution parameters.

TABLE 1

| | Inspection image | | Inspection image | | Composite | | Speckle | Image |
|---|---|---|---|---|---|---|---|---|
| | 502 (0°) | | 504 (90° | | Image | | Contrast | Correlation |
| Convolution | Mean | σ | Mean | σ | Mean | σ | Improvement | Coefficient |
| 1 × 1 | 37.8 | 31.1 | 37.8 | 32.5 | 37.8 | 22.6 | 1.41 | 0.00 |
| 2 × 2 | 37.8 | 26.1 | 37.8 | 27.0 | 37.8 | 18.8 | 1.41 | 0.01 |
| 3 × 3 | 37.8 | 22.1 | 37.8 | 22.7 | 37.8 | 15.9 | 1.41 | 0.01 |
| 4 × 4 | 37.8 | 19.7 | 37.8 | 20.3 | 37.8 | 14.2 | 1.41 | 0.01 |
| 5 × 5 | 37.8 | 17.9 | 37.8 | 18.4 | 37.8 | 12.9 | 1.40 | 0.01 |

Taken together, FIGS. 5A-5B and Table 1 demonstrate that the inspection images 502,504 generated with speckle decorrelation masks 118 are fully uncorrelated such that an associated composite image may provide a substantial reduction of speckle associated with surface haze. For example, the convolution size (e.g. pixel size used for convolution) does not change the speckle contrast improvement as depicted in Table 1.

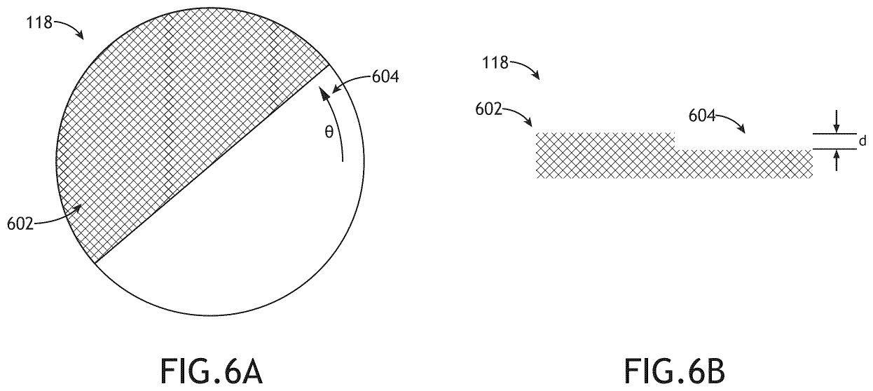

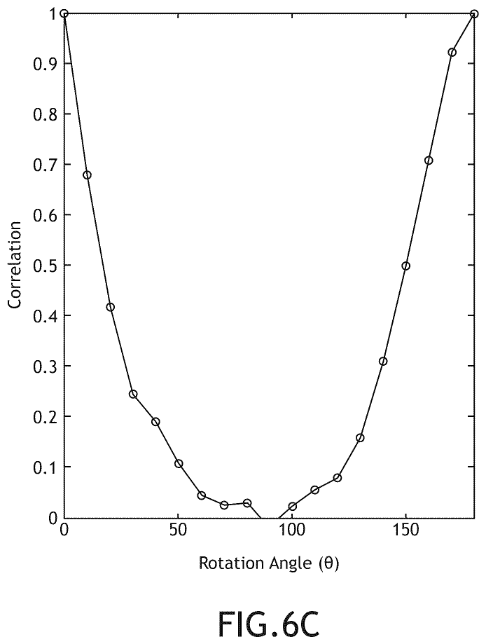

Referring now to FIGS. 6A-9, in some embodiments, a speckle decorrelation masks 118 introduces different phase shifts to sample light 114 in different portions of a collection pupil.

It is contemplated herein that another way to generate at least partially decorrelated inspection images is to generate inspection images with different phase mask distributions (or different rotational orientations of a phase mask distribution) in a collection pupil.

FIG. 6A illustrates a top view of one non-limiting design of a phase speckle decorrelation mask 118, in accordance with one or more embodiments of the present disclosure. FIG. 6B illustrates a side view of the phase speckle decorrelation mask 118 in FIG. 6A, in accordance with one or more embodiments of the present disclosure. In this configuration, the phase speckle decorrelation mask 118 introduces a first phase shift into a first half 602 of a collection pupil and a second phase shift into a second half 604 of the collection pupil. For example, such a phase speckle decorrelation mask 118 may introduce a phase difference of π between the first half 602 and the second half 604. As an illustration, the phase speckle decorrelation mask 118 may have a step height of

$$d = \frac{λ / 2}{n - 1}$$

between the first half 602 and the second half 604, where λ is a wavelength of light used for imaging (e.g., the sample light 114 and the illumination beam 106) and n is a refractive index of a material forming the phase speckle decorrelation mask 118.

FIG. 6C illustrates a plot of speckle correlation between inspection images generated with the phase speckle decorrelation mask 118 at various rotational angles θ relative to an inspection image generated with the phase speckle decorrelation mask 118 oriented at an angle θ of 0°, in accordance with one or more embodiments of the present disclosure. In FIG. 6C, the compared inspection images are generated with a common incidence angle of the illumination beam 106. As seen in FIG. 6C, inspection images generated with orthogonal rotation angles are fully decorrelated. More generally, the amount of correlation gradually varies as a function of the rotation angle.

Referring generally to FIGS. 6A-6C, it is to be understood that the particular design of the phase speckle decorrelation mask 118 in FIGS. 6A-6B is provided solely for illustrative purposes and should not be interpreted as limiting. Rather, a phase speckle decorrelation mask 118 may have any design suitable for inducing at least partial decorrelation between inspection images generated with different rotational configurations. For example, a phase speckle decorrelation mask 118 may provide a phase difference between one quadrant of the collection pupil and remaining areas of the collection pupil. As another example, a phase speckle decorrelation mask 118 may provide different phase shifts in three or more regions of the collection pupil. As another example, a phase speckle decorrelation mask 118 may provide a smoothly-varying phase profile across the collection pupil. Further, in some embodiments, different inspection images are generated with phase speckle decorrelation masks 118 with different configurations.

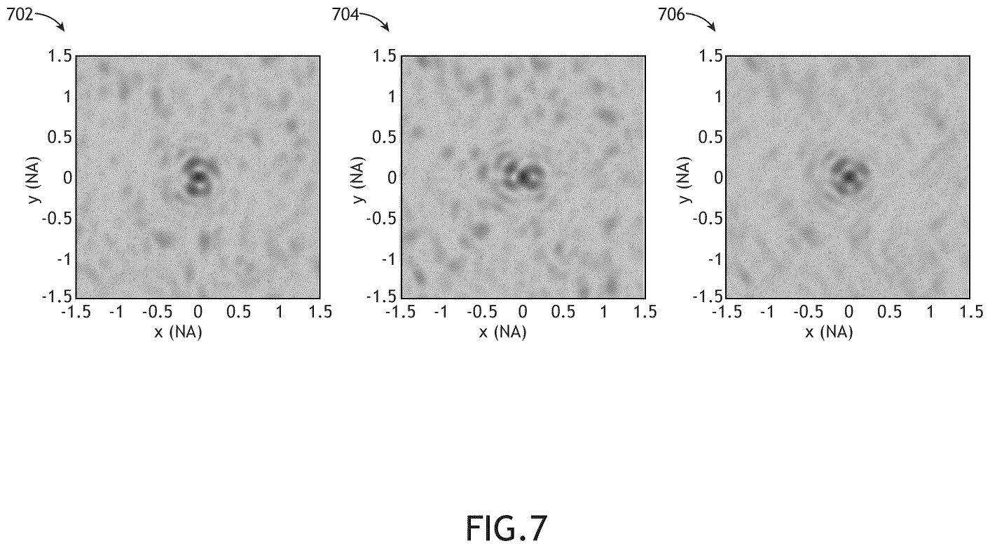

FIG. 7 illustrates simulations of speckle suppression using the phase speckle decorrelation mask 118 of FIGS. 6A-6B, in accordance with one or more embodiments of the present disclosure. In particular, inspection image 702 and inspection image 704 are generated with the phase speckle decorrelation mask 118 depicted in FIGS. 6A-6B orientated at orthogonal rotational angles (e.g., 0° and 90°).

Table 2 includes simulated SNR and speckle contrast for the inspection images 702,704 and a composite image 706 in FIG. 7 for different simulated pixel sizes.

TABLE 2

| | Inspection | Inspection | Composite |
|---|---|---|---|
| | image 702 | image 704 | Image 706 |
| Pixel Size < λ/10 | | | |
| SNR (RMS) | 32.85 | 27.65 | 40.93 |
| Speckle Contrast | 0.83 | 0.875 | 0.62 |
| Pixel Size~0.2 μm | | | |
| SNR (RMS) | 21.35 | 22.52 | 27.03 |
| Speckle Contrast | 0.54 | 0.53 | 0.42 |

As illustrated by FIG. 7 and Table 2, a composite image 706 generated by averaging the inspection image 702 with the inspection image 704 (e.g., in step 204 of the method 200) provides increased SNR of a defect signal relative to surface haze and a commensurate decrease in the speckle contrast. It is noted that the improvements may be more effective as the pixel size is reduced.

In some embodiments, inspection images are generated with multiple combinations of azimuth incidence angle and configurations of one or more phase speckle decorrelation masks 118. In this way, additional decorrelated inspection images may be generated.

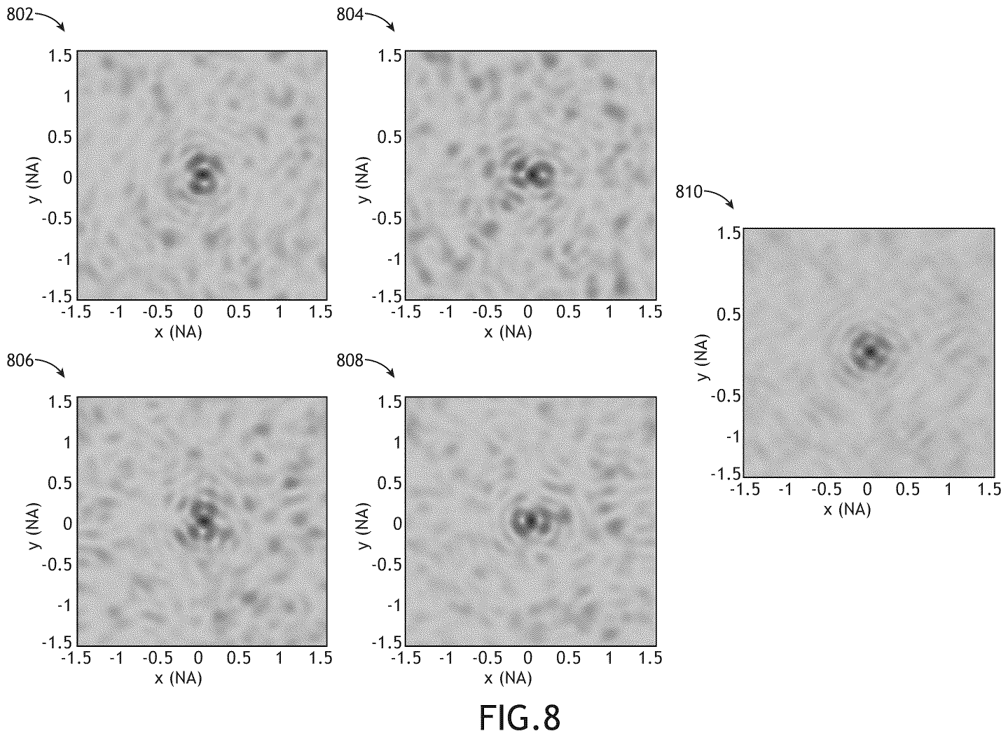

FIG. 8 illustrates simulations of surface haze suppression using inspection images with different combinations of azimuth incidence angle of an illumination beam 106 and rotational orientation of the phase speckle decorrelation mask 118 of FIGS. 6A-6B, in accordance with one or more embodiments of the present disclosure. In particular, inspection image 802 was generated with an azimuth incidence angle of 0° and a phase speckle decorrelation mask 118 orientation of 0°, inspection image 804 was generated with an azimuth incidence angle of 0° and a phase speckle decorrelation mask 118 orientation of 90°, inspection image 806 was generated with an azimuth incidence angle of 90° and a phase speckle decorrelation mask 118 orientation of 0°, and inspection image 808 was generated with an azimuth incidence angle of 90° and a phase speckle decorrelation mask 118 orientation of 90°. A composite image 810 was generated by averaging the inspection images 802-808.

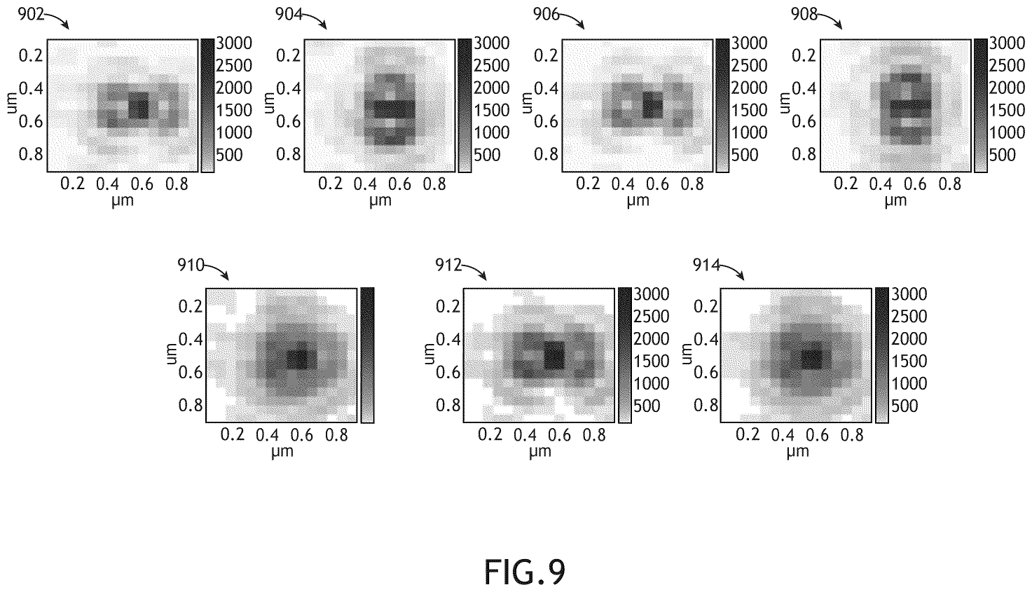

FIG. 9 illustrates experimental results for speckle suppression using inspection images with different combinations of azimuth incidence angle of an illumination beam 106 and rotational orientation of the phase speckle decorrelation mask 118 of FIGS. 6A-6B, in accordance with one or more embodiments of the present disclosure. In particular, inspection image 902 was generated with an azimuth incidence angle of 0° and a phase speckle decorrelation mask 118 orientation of 0°, inspection image 904 was generated with an azimuth incidence angle of 0° and a phase speckle decorrelation mask 118 orientation of 90°, inspection image 906 was generated with an azimuth incidence angle of 90° and a phase speckle decorrelation mask 118 orientation of 0°, and inspection image 908 was generated with an azimuth incidence angle of 90° and a phase speckle decorrelation mask 118 orientation of 90°.

FIG. 9 further includes a first composite image 910 generated by averaging the inspection image 902 with inspection image 904, a second composite image 912 generated by averaging the inspection image 906 with inspection image 908, and a third composite image 914 generated by averaging inspection images 902-908.

Table 3 includes measured SNR data associated with the inspection images 902-908 and the third composite image 914.

TABLE 3

| | Inspection | Inspection | Inspection | Inspection | Composite |
|---|---|---|---|---|---|
| | image 902 | image 904 | image 906 | image 908 | Image 912 |
| SNR (RMS) | 34.61 | 25.29 | 28.73 | 34.14 | 56.68 |

As illustrated in FIGS. 8-9, increasing a number of decorrelated inspection images combined into a composite image may generally increase an efficacy of speckle suppression and associated SNR increase. It is noted that the second composite image 912 associated with the combination of four inspection images provided a 1.85× improvement of SNR.

Referring now generally to FIGS. 3A-9, in some embodiments, though not shown, both intensity-type and phase-type speckle decorrelation masks 118 may be used in combination. For example, as illustrated in FIGS. 3A-5C, intensity speckle decorrelation masks 118 (or rotational variations of a common intensity speckle decorrelation mask 118) may be designed to provide decorrelated inspection images generated at different azimuth angles, where a collection NA is large enough to exhibit an overlap area 304 of projected pupils 302 that would lead to partial correlation in the absence of the intensity speckle decorrelation masks 118.

As an illustration, images 802,804,902,904 and the like generated with an azimuth incidence angle of 0° may be generated with an intensity speckle decorrelation mask 118 oriented as shown in panel 412 of FIG. 4C, whereas images 806,808,906,908 and the like generated with an azimuth incidence angle of 90° may be generated with an intensity speckle decorrelation mask 118 oriented as shown in panel 414 of FIG. 4C, which may provide even further improvements.

More generally, any number of at least partially decorrelated inspection images may be combined into a composite image for defect inspection, where the inspection images may be generated with any combination of azimuth incidence angle, intensity speckle decorrelation masks 118 (or orientations thereof), or phase speckle decorrelation masks 118 (or orientations thereof).

Referring again to FIGS. 1A-1B, additional aspects of the inspection system 100 are described in greater detail, in accordance with one or more embodiments of the present disclosure.

The illumination beam 106 may include one or more selected wavelengths of light including, but not limited to, ultraviolet (UV) radiation, visible radiation, or infrared (IR) radiation. For example, the illumination source 104 may provide, but is not required to provide, an illumination beam 106 having wavelengths shorter than approximately 350 nm. By way of another example, the illumination beam 106 may provide a wavelength of approximately 266 nm. By way of another example, the illumination beam 106 may provide a wavelength of approximately 213 nm. By way of another example, the illumination beam 106 may provide a wavelength of approximately 193 nm. It is recognized herein that imaging resolution and light scattering by small particles (e.g., relative to the wavelength of the illumination beam 106) both generally scale inversely with wavelength such that decreasing the wavelength of the illumination beam 106 may generally increase the imaging resolution and scattering signal from the small particles. Accordingly, the illumination beam 106 may include short-wavelength light including, but not limited to, extreme ultraviolet (EUV) light, deep ultraviolet (DUV) light, or vacuum ultraviolet (VUV) light.

The illumination beam 106 may further have any temporal profile. For example, the illumination beam 106 may have a continuous temporal profile, a modulated temporal profile, a pulsed temporal profile, or the like.

The illumination sub-system 102 may include any number of components to direct or otherwise manipulate the illumination beam 106. For example, the illumination sub-system 102 may include one or more illumination lenses 126 to focus and/or relay the illumination beam 106. The illumination lenses 126 may further provide any number of relayed illumination pupil planes and/or illumination field planes. As another example, the illumination sub-system 102 may include one or more illumination beam-controlling optics 128 such as, but not limited to apodizers, polarizers, spectral filters, neutral density filters, or homogenizers. Further, the illumination beam-controlling optics 128 may be located at any suitable location such as, but not limited to, an illumination pupil plane or an illumination field plane.

The imaging sub-system 110 may include any number of imaging beam-conditioning optics 130 to direct and/or modify the sample light 114 including, but not limited to, one or more lenses, one or more filters, one or more apertures, one or more polarizers, or one or more phase plates. In some embodiments, the imaging beam-conditioning optics 130 include one or more speckle decorrelation masks 118 (e.g., one or more intensity speckle decorrelation masks 118 and/or one or more phase speckle decorrelation masks 118).

The imaging sub-system 110 may include any number of lenses 132 to manipulate the sample light 114 collected by the objective lens 112. For example, the lenses 132 may operate with the objective lens 112 to generate an image of the sample 108 on a detector 116. In some embodiments, though not shown, the lenses 132 of the imaging sub-system 110 may relay one or more planes (e.g., relay one or more collection pupil planes 134 and/or collection field planes 136), which may allow for further manipulation of the sample light 114 with the imaging beam-conditioning optics 130.

It is recognized herein that a limited number of imaging beam-conditioning optics 130 (e.g., a limited number of speckle decorrelation masks 118) may be placed at a particular collection pupil plane 134 or sufficiently near a particular collection pupil plane 134 to provide a desired effect. Accordingly, for the purposes of the present disclosure, reference to one or more elements at a collection pupil plane 134 may generally describe one or more elements at or sufficiently close to a collection pupil plane 134 to produce a desired effect. However, the use of lenses 132 of the imaging sub-system 110 to relay one or more collection pupil planes 134 may enable the placement of multiple imaging beam-conditioning optics 130 (e.g., multiple speckle decorrelation masks 118 at different relayed collection pupil planes 134).

Additionally, a detector 116 may include any type of sensor known in the art suitable for measuring illumination received from the sample 108. For example, a detector 116 may include a multi-pixel detector suitable for capturing an image of the sample 108 such as, but not limited to, a charge-coupled device (CCD) detector, a complementary metal-oxide-semiconductor (CMOS) detector, a time-delayed integration (TDI) detector, a photomultiplier tube (PMT) array, an avalanche photodiode (APD) array, or the like. In embodiments, a detector 116 includes a spectroscopic detector suitable for identifying wavelengths of the sample light 114. Further, the imaging sub-system 110 may generally include any number of detectors 116.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include, but are not limited to, physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An inspection system comprising:
an illumination sub-system including one or more lenses configured to direct an illumination beam to be directed to a sample;
an imaging sub-system configured to image the sample on a detector, wherein the illumination sub-system and the imaging sub-system provide dark-field imaging of the sample, wherein the imaging sub-system comprises:
an objective lens to collect light from the sample as sample light; and
one or more speckle decorrelation masks in a collection pupil plane configured to control at least one of a phase or an intensity of at least a portion of the sample light; and
a controller including one or more processors configured to execute program instructions causing the one or more processors to implement an inspection recipe by:
receiving two or more inspection images of the sample from the detector, wherein the two or more inspection images are generated with different configurations of the one or more speckle decorrelation masks selected to at least partially decorrelate the two or more inspection images;
combining the two or more inspection images to generate a composite image; and
identifying one or more defects on the sample based on the composite image.

2. The inspection system of claim 1, wherein the different configurations of the one or more speckle decorrelation masks selected to at least partially decorrelate the two or more inspection images comprise different rotational orientations of a phase speckle decorrelation mask of the one or more speckle decorrelation masks, wherein the phase speckle decorrelation mask provides different phase shifts to different regions of the collection pupil plane.

3. The inspection system of claim 2, wherein the phase speckle decorrelation mask provides the different phase shifts to different halves of the collection pupil plane.

4. The inspection system of claim 3, wherein the phase speckle decorrelation mask provides a phase difference of π between the different halves of the collection pupil plane.

5. The inspection system of claim 2, wherein the different configurations of the one or more speckle decorrelation masks selected to at least partially decorrelate the two or more inspection images further comprise different azimuth incidence angles of the illumination beam.

6. The inspection system of claim 1, wherein a first inspection image is generated with a first azimuth incidence angle of the illumination beam and a first configuration of the one or more speckle decorrelation masks, wherein a second inspection image is generated with a second azimuth incidence angle of the illumination beam and a second configuration of the one or more speckle decorrelation masks, wherein the sample light in a first region of a collection pupil of the imaging sub-system when generating the first inspection image and a second region of the collection pupil of the imaging sub-system when generating the second inspection image are correlated, wherein the different configurations of the one or more speckle decorrelation masks selectively block the sample light in at least one of the first region or the second region to at least partially decorrelate the first inspection image and the second inspection image.

7. The inspection system of claim 6, wherein the first azimuth incidence angle is orthogonal to the second azimuth incidence angle.

8. The inspection system of claim 6, wherein the first region and the second region are associated with an overlap area of a projected collection pupil associated with generating the first inspection image in a global spatial frequency domain with a projected collection pupil associated with generating the second inspection image in the global spatial frequency domain.

9. The inspection system of claim 8, wherein the first configuration of the one or more speckle decorrelation masks includes a first blocker shaped to block the sample light associated with a first portion of the overlap area, wherein the second configuration of the one or more speckle decorrelation masks includes a second blocker shaped to block the sample light associated with a remaining portion of the overlap area.

10. The inspection system of claim 6, wherein the first configuration of the one or more speckle decorrelation masks provides a wedge aperture with an apex oriented at a location of the collection pupil associated with specular reflection of the illumination beam with the first azimuth incidence angle, wherein the second configuration of the one or more speckle decorrelation masks provides the wedge aperture with the apex oriented at a location of the collection pupil associated with specular reflection of the illumination beam with the second azimuth incidence angle.

11. The inspection system of claim 6, wherein the objective lens has a numerical aperture equal to or greater than 0.7.

12. The inspection system of claim 6, wherein the objective lens has a numerical aperture equal to or greater than 0.9.

13. An inspection method comprising:
generating two or more inspection images of a sample with an inspection system including one or more speckle decorrelation masks in a collection pupil plane configured to control at least one of a phase or an intensity of at least a portion of sample light collected in response to an illumination beam, wherein the two or more inspection images comprise dark-field images, wherein the two or more inspection images are generated with different configurations of the one or more speckle decorrelation masks selected to at least partially decorrelate the two or more inspection images;
combining the two or more inspection images to generate a composite image; and
identifying one or more defects on the sample based on the composite image.

14. The inspection method of claim 13, wherein the different configurations of the one or more speckle decorrelation masks selected to at least partially decorrelate the two or more inspection images comprise different rotational orientations of a phase speckle decorrelation mask of the one or more speckle decorrelation masks, wherein the phase speckle decorrelation mask provides different phase shifts to different regions of the collection pupil plane.

15. The inspection method of claim 14, wherein the phase speckle decorrelation mask provides the different phase shifts to different halves of the collection pupil plane.

16. The inspection method of claim 15, wherein the phase speckle decorrelation mask provides a phase difference of π between the different halves of the collection pupil plane.

17. The inspection method of claim 14, wherein the different configurations of the one or more speckle decorrelation masks selected to at least partially decorrelate the two or more inspection images further comprise different azimuth incidence angles of the illumination beam.

18. The inspection method of claim 13, wherein generating the two or more inspection images comprises:
generating a first inspection image is with a first azimuth incidence angle of the illumination beam and a first configuration of the one or more speckle decorrelation masks; and
generating a second inspection image with a second azimuth incidence angle of the illumination beam and a second configuration of the one or more speckle decorrelation masks, wherein the sample light in a first region of a collection pupil when generating the first inspection image and a second region of the collection pupil when generating the second inspection image are correlated, wherein the different configurations of the one or more speckle decorrelation masks selectively block the sample light in at least one of the first region or the second region to at least partially decorrelate the first inspection image and the second inspection image.

19. The inspection method of claim 18, wherein the first azimuth incidence angle is orthogonal to the second azimuth incidence angle.

20. The inspection method of claim 18, wherein the first region and the second region are associated with an overlap area of a projected collection pupil associated with generating the first inspection image in a global spatial frequency domain with a projected collection pupil associated with generating the second inspection image in the global spatial frequency domain.

21. The inspection method of claim 20, wherein the first configuration of the one or more speckle decorrelation masks includes a first blocker shaped to block the sample light associated with a first portion of the overlap area, wherein the second configuration of the one or more speckle decorrelation masks includes a second blocker shaped to block the sample light associated with a remaining portion of the overlap area.

22. The inspection method of claim 18, wherein generating the two or more inspection images comprises:
generating the first inspection image with the first configuration of the one or more speckle decorrelation masks providing a wedge aperture with an apex oriented at a location of the collection pupil associated with specular reflection of the illumination beam with the first azimuth incidence angle; and
generating the second inspection image with the second configuration of the one or more speckle decorrelation masks providing the wedge aperture with the apex oriented at a location of the collection pupil associated with specular reflection of the illumination beam with the second azimuth incidence angle.

23. An inspection system comprising:
a controller including one or more processors configured to execute program instructions causing the one or more processors to implement an inspection recipe by:
directing an imaging sub-system to generate two or more inspection images of a sample, wherein the imaging sub-system comprises:
an objective lens to collect light from the sample as sample light; and
one or more speckle decorrelation masks in a collection pupil plane configured to control at least one of a phase or an intensity of at least a portion of the sample light, wherein the two or more inspection images are generated with different configurations of the one or more speckle decorrelation masks selected to at least partially decorrelate the two or more inspection images;
combining the two or more inspection images to generate a composite image; and
identifying one or more defects on the sample based on the composite image.
